(19) United States
(12) Patent Application Publication
(10) Pub. No.: US 2026/0331841 A1
(43) Pub. Date: Oct. 22, 2026

(54) Electrical Connector

(71) Applicants: Tarng Yu Enterprise co., ltd., New Taipei City (TW); Dongguan Tarng Yu Electronics Co., Ltd., Dongguan City (CN)

(72) Inventors: YING-CHUNG CHEN, New Taipei City (TW); MU-JUNG HUANG, New Taipei City (TW)

(21) Appl. No.: 19/651,486

(22) Filed: Apr. 17, 2026

(30) Foreign Application Priority Data
Apr. 18, 2025 (TW) 114114875

(51) Int. Cl. H01R 13/6597; H01R 12/70; H01R 12/71; H01R 13/24; H01R 13/502

(52) U.S. Cl. CPC H01R 13/6597; H01R 12/7082; H01R 12/714; H01R 13/24; H01R 13/502

(57) ABSTRACT

An electrical connector comprising a plurality of non-grounded conductive terminal sets and a shielding conductive member, wherein the shielding conductive member is disposed between the plurality of non-grounded conductive terminal sets, and the shielding conductive member transmits a shielding signal such as a grounded signal to provide electrical shielding for signal transmission through the plurality of non-grounded conductive terminal sets. Thus, interference during high-speed signal transmission of the electrical connector can be effectively reduced, thereby optimizing the transmission quality of high-speed signals for the electrical connector to meet specific requirements and development of electronic devices.

### CROSS-REFERENCE TO RELATED APPLICATIONS

This application claims the priority of Republic of China Patent Application No. 114114875 filed on Apr. 18, 2025, in the State Intellectual Property Office of the R.O.C., the disclosure of which is incorporated herein by reference.

### BACKGROUND OF THE INVENTION

### Field of the Invention

The present application relates to the technical field of electronic devices, and more particularly, to an electrical connector capable of reducing interference during high-speed signal transmission.

### Description of the Related Art

In recent years, electrical connectors have been widely used in various electronic devices that can thus transmit signals through a plurality of conductive terminals on the electrical connectors. The plurality of conductive terminals of the electrical connector may be required for transmitting high-speed signals in response to the specific requirements and development of the electronic devices. However, the current electrical connectors are susceptible to interference when transmitting high-speed signals (the interference is, for example, electromagnetic interference from the external environment, or crosstalk interference caused by coupling between the plurality of conductive terminals of the electrical connector), which causes the high-speed signals transmitted by the electrical connector to be prone to quality degradation.

From the above, how to solve the problem that electrical connectors are susceptible to interference during high-speed signal transmission is indeed an urgent problem to be solved by those skilled in the art.

### SUMMARY OF THE INVENTION

In view of the drawbacks of the prior art mentioned above, the present application provides an electrical connector, two sides of the electrical connector being an electrical connector major side and an electrical connector minor side, the electrical connector comprising: an electrical connector body comprising a coupling space, a major side non-grounded conductive terminal separating space, and a minor side non-grounded conductive terminal separating space; a major side electrical connector submodule disposed at the electrical connector major side, the major side electrical connector submodule comprising a major side non-grounded conductive terminal set, the major side non-grounded conductive terminal set comprising a first major side non-grounded conductive terminal and a second major side non-grounded conductive terminal, wherein the major side non-grounded conductive terminal separating space is disposed between the first major side non-grounded conductive terminal and the second major side non-grounded conductive terminal to separate the first major side non-grounded conductive terminal from the second major side non-grounded conductive terminal, and the first major side non-grounded conductive terminal and the second major side non-grounded conductive terminal extend into the coupling space to provide coupling; a minor side electrical connector submodule disposed at the electrical connector minor side, the minor side electrical connector submodule comprising a minor side non-grounded conductive terminal set, the minor side non-grounded conductive terminal set comprising a first minor side non-grounded conductive terminal and a second minor side non-grounded conductive terminal, wherein the minor side non-grounded conductive terminal separating space is disposed between the first minor side non-grounded conductive terminal and the second minor side non-grounded conductive terminal to separate the first minor side non-grounded conductive terminal from the second minor side non-grounded conductive terminal, and the first minor side non-grounded conductive terminal and the second minor side non-grounded conductive terminal extend into the coupling space to provide coupling; a coupling space shielding conductive member extending into the coupling space to provide electrical shielding between the major side non-grounded conductive terminal set and the minor side non-grounded conductive terminal set; and a grounded conductive terminal extending from the electrical connector major side into the major side non-grounded conductive terminal separating space to provide electrical shielding between the first major side non-grounded conductive terminal and the second major side non-grounded conductive terminal; the grounded conductive terminal further extending from the electrical connector minor side into the minor side non-grounded conductive terminal separating space to provide electrical shielding between the first minor side non-grounded conductive terminal and the second minor side non-grounded conductive terminal; the grounded conductive terminal further extending from the electrical connector major side and the electrical connector minor side into the coupling space to provide coupling; and the grounded conductive terminal comprising a coupling space shielding conductive member mating structure, wherein the coupling space shielding conductive member mating structure is mated with the coupling space shielding conductive member to position the coupling space shielding conductive member and to electrically connect the grounded conductive terminal to the coupling space shielding conductive member.

Preferably, the electrical connector said above, wherein the coupling space shielding conductive member is a conductive metal member.

Preferably, the electrical connector said above, wherein the coupling space shielding conductive member comprises a major side coupling space shielding conductive sub-member and a minor side coupling space shielding conductive sub-member; wherein the major side coupling space shielding conductive sub-member comprises a major side coupling space shielding conductive sub-member shielding wall extending from the electrical connector major side into the coupling space to provide electrical shielding between the major side non-grounded conductive terminal set and the minor side non-grounded conductive terminal set; and the minor side coupling space shielding conductive sub-member comprises a minor side coupling space shielding conductive sub-member shielding wall extending from the electrical connector minor side into the coupling space to provide electrical shielding between the major side non-grounded conductive terminal set and the minor side non-grounded conductive terminal set; and the coupling space shielding conductive member mating structure comprises a major side coupling space shielding conductive member mating substructure and a minor side coupling space shielding conductive member mating substructure, wherein the major side coupling space shielding conductive member mating substructure is mated with the major side coupling space shielding conductive sub-member to position the major side coupling space shielding conductive sub-member and to electrically connect the grounded conductive terminal to the major side coupling space shielding conductive sub-member, and the minor side coupling space shielding conductive member mating substructure is mated with the minor side coupling space shielding conductive sub-member to position the minor side coupling space shielding conductive sub-member and to electrically connect the grounded conductive terminal to the minor side coupling space shielding conductive sub-member.

Preferably, the electrical connector said above, wherein the major side coupling space shielding conductive sub-member further comprises a major side coupling space shielding conductive sub-member abutting wall, and the minor side coupling space shielding conductive sub-member further comprises a minor side coupling space shielding conductive sub-member abutting wall, wherein the major side coupling space shielding conductive sub-member abutting wall is configured to abut the minor side coupling space shielding conductive sub-member abutting wall to electrically connect the major side coupling space shielding conductive sub-member to the minor side coupling space shielding conductive sub-member.

Preferably, the electrical connector said above, wherein the major side coupling space shielding conductive sub-member further comprises a major side coupling space shielding conductive sub-member connecting wall, and the minor side coupling space shielding conductive sub-member further comprises a minor side coupling space shielding conductive sub-member connecting wall; wherein the major side coupling space shielding conductive sub-member connecting wall is configured to connect the major side coupling space shielding conductive sub-member shielding wall to the major side coupling space shielding conductive sub-member abutting wall; the minor side coupling space shielding conductive sub-member connecting wall is configured to connect the minor side coupling space shielding conductive sub-member shielding wall to the minor side coupling space shielding conductive sub-member abutting wall; the major side coupling space shielding conductive member mating substructure is mated with the major side coupling space shielding conductive sub-member connecting wall; and the minor side coupling space shielding conductive member mating substructure is mated with the minor side coupling space shielding conductive sub-member connecting wall.

Preferably, the electrical connector said above, wherein the major side coupling space shielding conductive sub-member connecting wall substantially perpendicularly intersects with the major side coupling space shielding conductive sub-member shielding wall and the major side coupling space shielding conductive sub-member abutting wall respectively; and the minor side coupling space shielding conductive sub-member connecting wall substantially perpendicularly intersects with the minor side coupling space shielding conductive sub-member shielding wall and the minor side coupling space shielding conductive sub-member abutting wall respectively.

Preferably, the electrical connector said above, wherein the major side electrical connector submodule further comprises a major side terminal insulation core mated with the major side non-grounded conductive terminal set to position the first major side non-grounded conductive terminal and the second major side non-grounded conductive terminal; the minor side electrical connector submodule further comprises a minor side terminal insulation core mated with the minor side non-grounded conductive terminal set to position the first minor side non-grounded conductive terminal and the second minor side non-grounded conductive terminal; and the grounded conductive terminal further comprises a major side terminal insulation core mating structure and a minor side terminal insulation core mating structure, wherein the major side terminal insulation core mating structure is mated with the major side terminal insulation core to position the major side terminal insulation core, and the minor side terminal insulation core mating structure is mated with the minor side terminal insulation core to position the minor side terminal insulation core.

Preferably, the electrical connector said above, further comprising: an insulation housing mated with the major side terminal insulation core and the minor side terminal insulation core to position the major side terminal insulation core and the minor side terminal insulation core.

Preferably, the electrical connector said above, wherein the electrical connector body further comprises a engaging space; the first major side non-grounded conductive terminal and the second major side non-grounded conductive terminal further extend into the engaging space to provide engaging; the first minor side non-grounded conductive terminal and the second minor side non-grounded conductive terminal further extend into the engaging space to provide engaging; the grounded conductive terminal further extends from the electrical connector major side and the electrical connector minor side into the engaging space to provide engaging; the electrical connector further comprises a engaging space shielding conductive member extending into the engaging space to provide electrical shielding between the major side non-grounded conductive terminal set and the minor side non-grounded conductive terminal set; and the grounded conductive terminal further comprises a engaging space shielding conductive member mating structure mated with the engaging space shielding conductive member to position the engaging space shielding conductive member and to electrically connect the grounded conductive terminal to the engaging space shielding conductive member.

Preferably, the electrical connector said above, wherein the engaging space shielding conductive member is a conductive plastic member.

Compared to the prior art, the electrical connector provided by the present application can be disposed in an electronic device for signal transmission, and the electrical connector comprises a plurality of non-grounded conductive terminal sets, a shielding conductive member and a grounded conductive terminal. Wherein, the shielding conductive member is disposed between the plurality of non-grounded conductive terminal sets, the grounded conductive terminal is capable of being electrically connected to the shielding conductive member to transmit a shielding signal such as a grounded signal to provide electrical shielding for signal transmission of the plurality of non-grounded conductive terminal sets. Thus, interference during high-speed signal transmission of the electrical connector can be effectively reduced, thereby optimizing the transmission quality of the electrical connector for high-speed signals to meet specific requirements and development of electronic devices.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective schematic view of the electrical connector of the present application in one embodiment.

FIG. 2 is a perspective schematic view from a first perspective of the electrical connector of the present application in one embodiment.

FIG. 3 is a perspective schematic view from a second perspective of the electrical connector of the present application in one embodiment.

FIG. 4 is a front schematic view of the electrical connector of the present application in one embodiment.

FIG. 5 is a cross-sectional schematic view of some members of the electrical connector shown in FIG. 4 taken along line AA.

FIG. 6 is a cross-sectional schematic view of some members of the electrical connector shown in FIG. 4 taken along line BB.

FIG. 7 is a cross-sectional schematic view of some members of the electrical connector shown in FIG. 4 taken along line CC.

FIG. 8 is a perspective schematic view of the electrical connector of the present application in one embodiment.

FIG. 9 is a perspective schematic view of the electrical connector of the present application in one embodiment.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

The present application provides an electrical connector. The electrical connector is disposed with a plurality of non-grounded conductive terminal sets and a shielding conductive member, wherein the shielding conductive member is disposed between the plurality of non-grounded conductive terminal sets, and the shielding conductive member transmits a shielding signal such as a grounded signal to provide electrical shielding for signal transmission of the plurality of non-grounded conductive terminal sets. Thus, interference during high-speed signal transmission of the electrical connector can be effectively reduced, thereby optimizing the transmission quality of the electrical connector for high-speed signals to meet specific requirements and development of electronic devices.

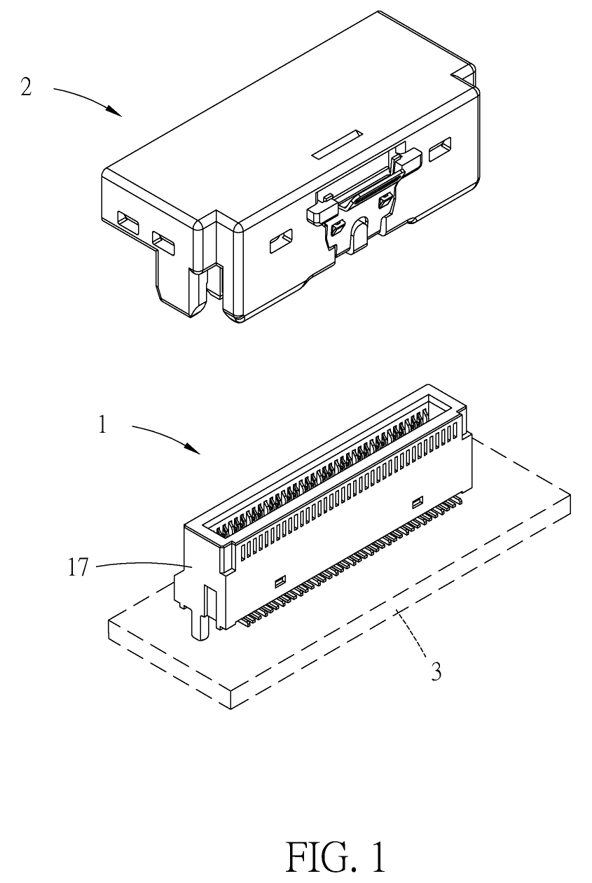

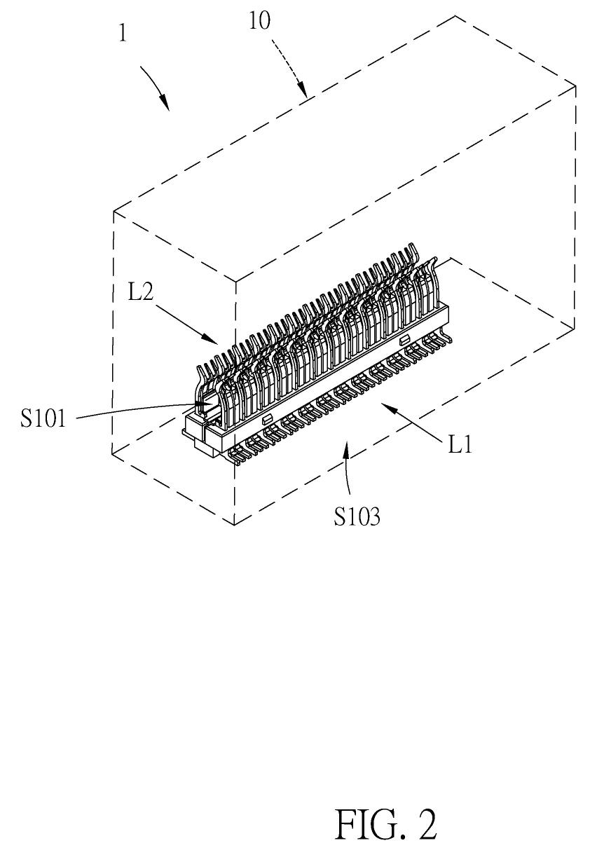

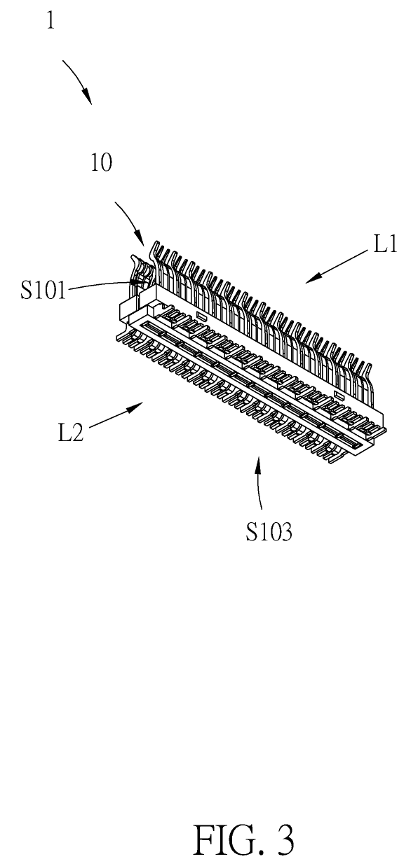

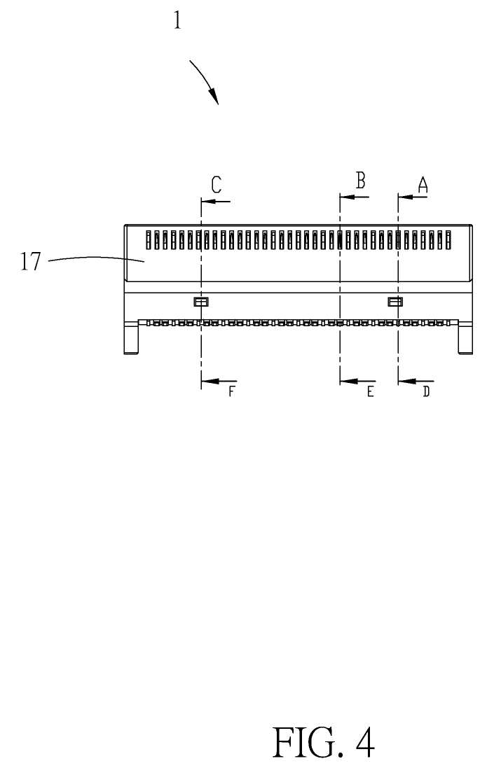

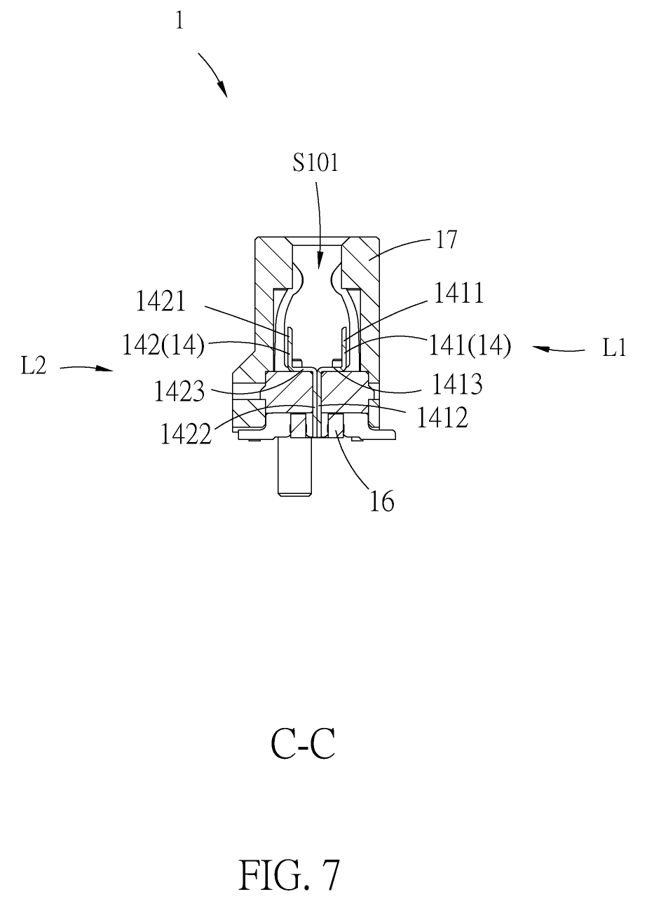

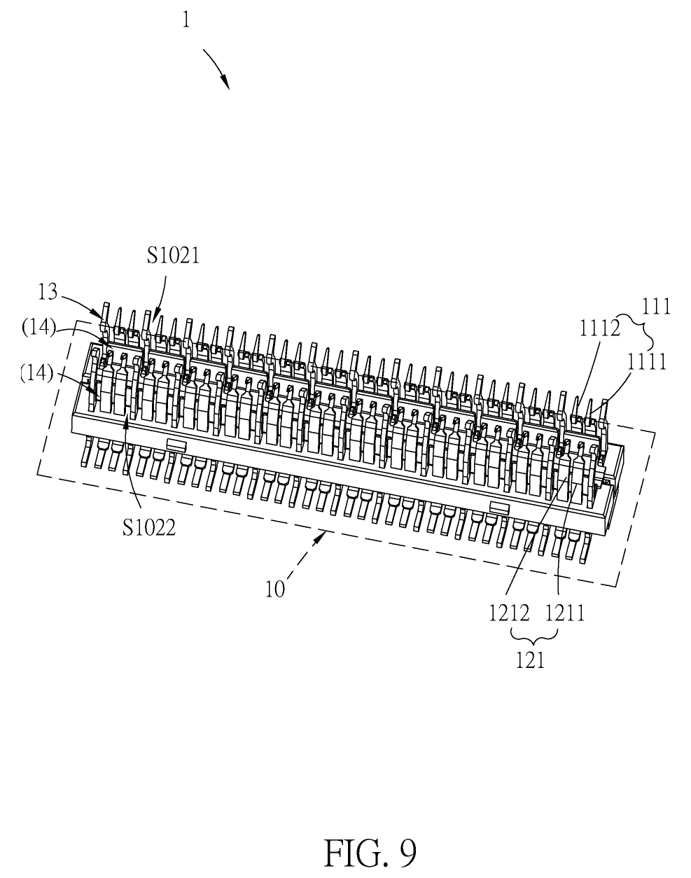

For a detailed description of the embodiments disclosed in the present application, please refer to FIGS. 1-9.

In the above embodiments, an electrical connector 1 is provided. The electrical connector 1 is capable of coupling an engaging member 2 to provide transmission signals, and two sides of the electrical connector 1 are capable of being defined as an electrical connector major side L1 and an electrical connector minor side L2, respectively. It should be noted that the engaging member 2 is, for example, a mating connector capable of providing transmission signals.

In the embodiments shown in FIGS. 1-9, the electrical connector 1 comprises: an electrical connector body 10, a major side electrical connector submodule 11, a minor side electrical connector submodule 12, a coupling space shielding conductive member 14, a grounded conductive terminal 13, and an insulation housing 17.

Regarding the electrical connector body 10, the electrical connector body 10 comprises a coupling space S101, a major side non-grounded conductive terminal separating space S1021 and a minor side non-grounded conductive terminal separating space S1022.

Regarding the major side electrical connector submodule 11, the major side electrical connector submodule 11 is disposed at the electrical connector major side L1, and the major side electrical connector submodule 11 comprises a major side terminal insulation core 110 and a major side non-grounded conductive terminal set 111. The major side non-grounded conductive terminal set 111 is capable of providing transmission of non-grounded signals such as differential signals, and the major side non-grounded conductive terminal set 111 comprises at least one first major side non-grounded conductive terminal 1111 and at least one second major side non-grounded conductive terminal 1112. The major side terminal insulation core 110 is made of insulation material, and the major side terminal insulation core 110 is mated with the major side non-grounded conductive terminal set 111 to provide positioning for the first major side non-grounded conductive terminal 1111 and the second major side non-grounded conductive terminal 1112. Wherein the major side non-grounded conductive terminal separating space S1021 is disposed between the first major side non-grounded conductive terminal 1111 and the second major side non-grounded conductive terminal 1112 to separate the first major side non-grounded conductive terminal 1111 from the second major side non-grounded conductive terminal 1112; and the first major side non-grounded conductive terminal 1111 and the second major side non-grounded conductive terminal 1112 extend into the coupling space S101 to provide coupling with the engaging member 2 for signal transmission.

Regarding the minor side electrical connector submodule 12, the minor side electrical connector submodule 12 is disposed at the electrical connector minor side L2, and the minor side electrical connector submodule 12 comprises a minor side terminal insulation core 120 and a minor side non-grounded conductive terminal set 121. The minor side non-grounded conductive terminal set 121 is capable of providing transmission of non-grounded signals such as differential signals, and the minor side non-grounded conductive terminal set 121 comprises at least one first minor side non-grounded conductive terminal 1211 and at least one second minor side non-grounded conductive terminal 1212. The minor side terminal insulation core 120 is made of insulation material, and the minor side terminal insulation core 120 is mated with the minor side non-grounded conductive terminal set 121 to provide positioning for the first minor side non-grounded conductive terminal 1211 and the second minor side non-grounded conductive terminal 1212. Wherein the minor side non-grounded conductive terminal separating space S1022 is disposed between the first minor side non-grounded conductive terminal 1211 and the second minor side non-grounded conductive terminal 1212 to separate the first minor side non-grounded conductive terminal 1211 from the second minor side non-grounded conductive terminal 1212; and the first minor side non-grounded conductive terminal 1211 and the second minor side non-grounded conductive terminal 1212 extend into the coupling space S101 to provide coupling with the engaging member 2 for signal transmission.

Regarding the coupling space shielding conductive member 14, the coupling space shielding conductive member 14 is capable of transmitting a shielding signal such as a grounded signal, and the coupling space shielding conductive member 14 extends into the coupling space S101 to provide electrical shielding between the major side non-grounded conductive terminal set 111 and the minor side non-grounded conductive terminal set 121, thereby reducing interference in signal transmission of the major side non-grounded conductive terminal set 111 and the minor side non-grounded conductive terminal set 121. Thus, the coupling space shielding conductive member 14 can provide electrical shielding to reduce interference during high-speed signal transmission of the electrical connector 1, thereby optimizing the transmission quality of the electrical connector 1 for high-speed signals to meet specific requirements and development of electronic devices. It should be noted that the coupling space shielding conductive member 14 is, for example, a conductive metal member capable of transmitting shielding signals.

Regarding the grounded conductive terminal 13, the grounded conductive terminal 13 is capable of transmitting a shielding signal such as a grounded signal, and the grounded conductive terminal 13 extends into the major side non-grounded conductive terminal separating space S1021 at the electrical connector major side L1 to provide electrical shielding between the first major side non-grounded conductive terminal 1111 and the second major side non-grounded conductive terminal 1112, thereby reducing interference in signal transmission of the first major side non-grounded conductive terminal 1111 and the second major side non-grounded conductive terminal 1112. And the grounded conductive terminal 13 further extends into the minor side non-grounded conductive terminal separating space S1022 at the electrical connector minor side L2 to provide electrical shielding between the first minor side non-grounded conductive terminal 1211 and the second minor side non-grounded conductive terminal 1212, thereby reducing interference in signal transmission of the first minor side non-grounded conductive terminal 1211 and the second minor side non-grounded conductive terminal 1212. Thus, the grounded conductive terminal 13 can provide electrical shielding to reduce interference during high-speed signal transmission of the electrical connector 1, thereby optimizing the transmission quality of the electrical connector 1 for high-speed signals to meet specific requirements and development of electronic devices. Additionally, the grounded conductive terminal 13 further extends into the coupling space S101 at the electrical connector major side L1 and the electrical connector minor side L2 to provide coupling with the engaging member 2 for signal transmission.

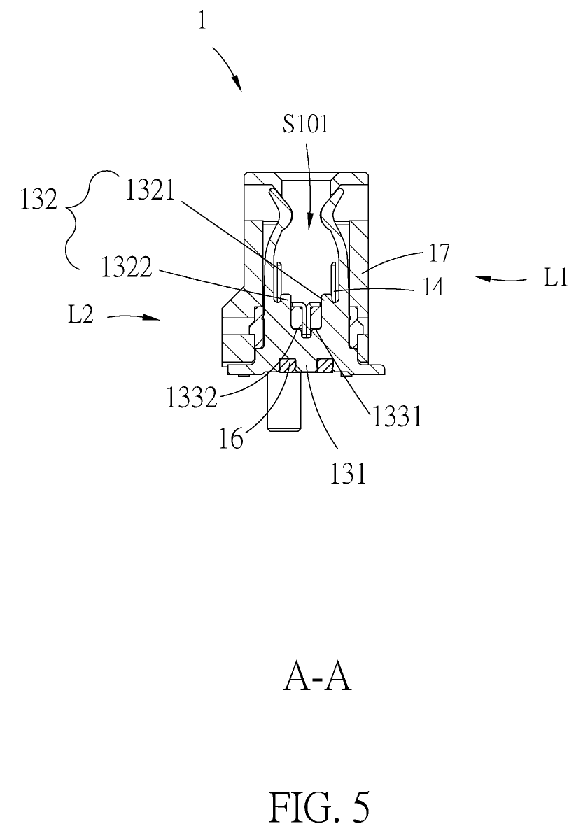

In the embodiment shown in FIG. 5, the grounded conductive terminal 13 comprises a coupling space shielding conductive member mating structure 132, a major side terminal insulation core mating structure 1331, and a minor side terminal insulation core mating structure 1332. Wherein the coupling space shielding conductive member mating structure 132 is mated with the coupling space shielding conductive member 14 to provide positioning for the coupling space shielding conductive member 14 and electrically connect the grounded conductive terminal 13 to the coupling space shielding conductive member 14 to transmit shielding signals; the major side terminal insulation core mating structure 1331 is mated with the major side terminal insulation core 110 to provide positioning for the major side terminal insulation core 110; and the minor side terminal insulation core mating structure 1332 is mated with the minor side terminal insulation core 120 to provide positioning for the minor side terminal insulation core 120.

Regarding the insulation housing 17, the insulation housing 17 is mated with the major side terminal insulation core 110 and the minor side terminal insulation core 120 to provide positioning for the major side terminal insulation core 110 and the minor side terminal insulation core 120.

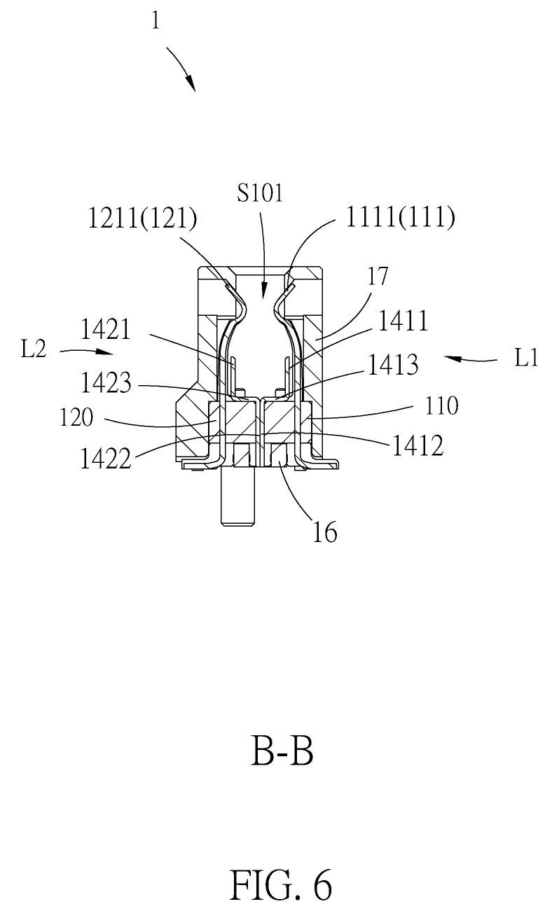

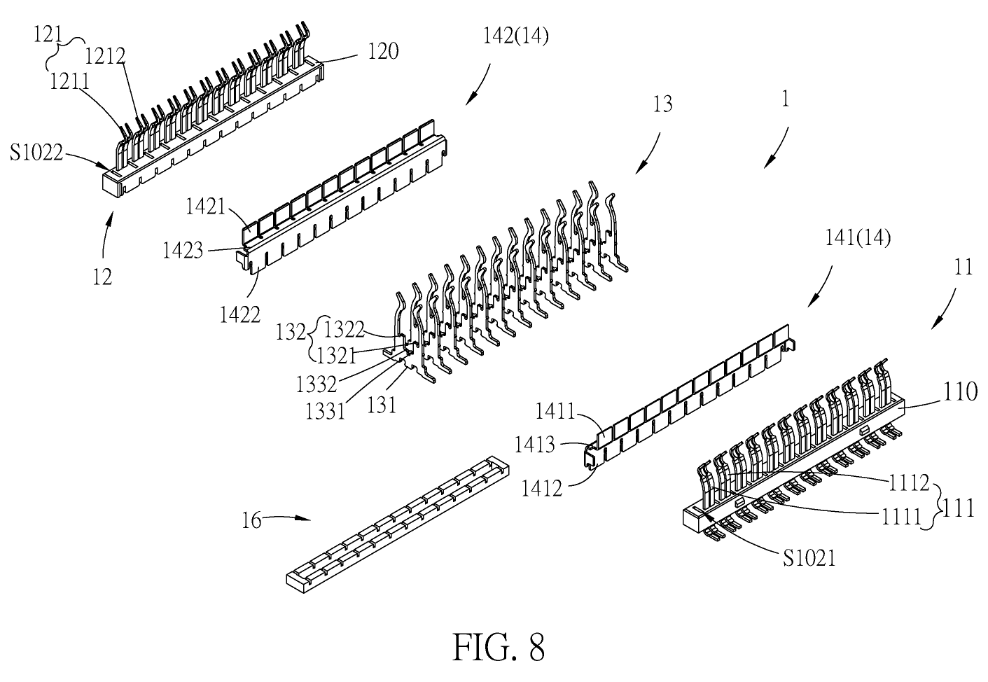

In the embodiments shown in FIGS. 6 and 8, the coupling space shielding conductive member 14 comprises a major side coupling space shielding conductive sub-member 141 and a minor side coupling space shielding conductive sub-member 142. Wherein the major side coupling space shielding conductive sub-member 141 comprises a major side coupling space shielding conductive sub-member shielding wall 1411, the major side coupling space shielding conductive sub-member shielding wall 1411 extends into the coupling space S101 at the electrical connector major side L1 to provide electrical shielding between the major side non-grounded conductive terminal set 111 and the minor side non-grounded conductive terminal set 121, thereby reducing interference in signal transmission of the major side non-grounded conductive terminal set 111 and the minor side non-grounded conductive terminal set 121; and the minor side coupling space shielding conductive sub-member 142 comprises a minor side coupling space shielding conductive sub-member shielding wall 1421, the minor side coupling space shielding conductive sub-member shielding wall 1421 extends into the coupling space S101 at the electrical connector minor side L2 to provide electrical shielding between the major side non-grounded conductive terminal set 111 and the minor side non-grounded conductive terminal set 121, thereby reducing interference in signal transmission of the major side non-grounded conductive terminal set 111 and the minor side non-grounded conductive terminal set 121. Thus, the major side coupling space shielding conductive sub-member 141 and the minor side coupling space shielding conductive sub-member 142 can respectively provide electrical shielding to reduce interference during high-speed signal transmission of the electrical connector 1, thereby optimizing the transmission quality of the electrical connector 1 for high-speed signals to meet specific requirements and development of electronic devices.

Accordingly, the coupling space shielding conductive member mating structure 132 comprises a major side coupling space shielding conductive member mating substructure 1321 and a minor side coupling space shielding conductive member mating substructure 1322. Wherein the major side coupling space shielding conductive member mating substructure 1321 is mated with the major side coupling space shielding conductive sub-member 141 to provide positioning for the major side coupling space shielding conductive sub-member 141 and electrically connect the grounded conductive terminal 13 to the major side coupling space shielding conductive sub-member 141 to transmit shielding signals; and the minor side coupling space shielding conductive member mating substructure 1322 is mated with the minor side coupling space shielding conductive sub-member 142 to provide positioning for the minor side coupling space shielding conductive sub-member 142 and electrically connect the grounded conductive terminal 13 to the minor side coupling space shielding conductive sub-member 142 to transmit shielding signals.

In the embodiments shown in FIGS. 6 and 8, the major side coupling space shielding conductive sub-member 141 further comprises a major side coupling space shielding conductive sub-member abutting wall 1412, and the minor side coupling space shielding conductive sub-member 142 further comprises a minor side coupling space shielding conductive sub-member abutting wall 1422; wherein the major side coupling space shielding conductive sub-member abutting wall 1412 is capable of abutting the minor side coupling space shielding conductive sub-member abutting wall 1422 to electrically connect the major side coupling space shielding conductive sub-member 141 to the minor side coupling space shielding conductive sub-member 142 to transmit shielding signals.

In the embodiments shown in FIGS. 6 and 8, the major side coupling space shielding conductive sub-member 141 further comprises a major side coupling space shielding conductive sub-member connecting wall 1413, and the minor side coupling space shielding conductive sub-member 142 further comprises a minor side coupling space shielding conductive sub-member connecting wall 1423; wherein the major side coupling space shielding conductive sub-member connecting wall 1413 connects the major side coupling space shielding conductive sub-member shielding wall 1411 to the major side coupling space shielding conductive sub-member abutting wall 1412 to provide positioning for and transmit shielding signals to the major side coupling space shielding conductive sub-member shielding wall 1411 and the major side coupling space shielding conductive sub-member abutting wall 1412; the minor side coupling space shielding conductive sub-member connecting wall 1423 connects the minor side coupling space shielding conductive sub-member shielding wall 1421 to the minor side coupling space shielding conductive sub-member abutting wall 1422 to provide positioning for and transmit shielding signals to the minor side coupling space shielding conductive sub-member shielding wall 1421 and the minor side coupling space shielding conductive sub-member abutting wall 1422.

It should be noted that in the above embodiments, the major side coupling space shielding conductive member mating substructure 1321 is optionally capable of mating with the major side coupling space shielding conductive sub-member connecting wall 1413; the minor side coupling space shielding conductive member mating substructure 1322 is optionally capable of mating with the minor side coupling space shielding conductive sub-member connecting wall 1423; the major side coupling space shielding conductive sub-member connecting wall 1413 optionally substantially perpendicularly intersects with the major side coupling space shielding conductive sub-member shielding wall 1411 and the major side coupling space shielding conductive sub-member abutting wall 1412 respectively; and the minor side coupling space shielding conductive sub-member connecting wall 1423 optionally substantially perpendicularly intersects with the minor side coupling space shielding conductive sub-member shielding wall 1421 and the minor side coupling space shielding conductive sub-member abutting wall 1422 respectively.

In the embodiment shown in FIG. 1, the electrical connector 1 is further capable of engaging a engaging member 3 to provide transmission signals. Accordingly, the electrical connector body 10 further comprises a engaging space S103; the first major side non-grounded conductive terminal 1111 and the second major side non-grounded conductive terminal 1112 further extend into the engaging space S103 to provide engaging for the engaging member 3; the first minor side non-grounded conductive terminal 1211 and the second minor side non-grounded conductive terminal 1212 further extend into the engaging space S103 to provide engaging for the engaging member 3; the grounded conductive terminal 13 further extends into the engaging space S103 at the electrical connector major side L1 and the electrical connector minor side L2 to provide engaging for the engaging member 3 for signal transmission.

The electrical connector 1 further comprises a engaging space shielding conductive member 16, the engaging space shielding conductive member 16 extends into the engaging space S103 to provide electrical shielding between the major side non-grounded conductive terminal set 111 and the minor side non-grounded conductive terminal set 121, thereby reducing interference in signal transmission of the major side non-grounded conductive terminal set 111 and the minor side non-grounded conductive terminal set 121. Thus, the engaging space shielding conductive member 16 can provide electrical shielding to reduce interference during high-speed signal transmission of the electrical connector 1, thereby optimizing the transmission quality of the electrical connector 1 for high-speed signals to meet specific requirements and development of electronic devices.

Accordingly, the grounded conductive terminal 13 further comprises a engaging space shielding conductive member mating structure 131, the engaging space shielding conductive member mating structure 131 is mated with the engaging space shielding conductive member 16 to provide positioning for the engaging space shielding conductive member 16 and electrically connect the grounded conductive terminal 13 to the engaging space shielding conductive member 16 to transmit shielding signals. It should be noted that the engaging space shielding conductive member 16 is, for example, a conductive plastic member capable of transmitting shielding signals.

It should be noted that in the embodiments of the present application, the aforementioned some members can also be omitted. For example, the electrical connector of the present application optionally comprises: an electrical connector body, a major side electrical connector submodule, a minor side electrical connector submodule, a coupling space shielding conductive member and a grounded conductive terminal; the electrical connector body comprises a coupling space, a major side non-grounded conductive terminal separating space and a minor side non-grounded conductive terminal separating space; the major side electrical connector submodule is disposed at the electrical connector major side, and the major side electrical connector submodule comprises a major side non-grounded conductive terminal set, the major side non-grounded conductive terminal set comprises a first major side non-grounded conductive terminal and a second major side non-grounded conductive terminal, wherein the major side non-grounded conductive terminal separating space is disposed between the first major side non-grounded conductive terminal and the second major side non-grounded conductive terminal to separate the first major side non-grounded conductive terminal from the second major side non-grounded conductive terminal; and the first major side non-grounded conductive terminal and the second major side non-grounded conductive terminal extend into the coupling space to provide coupling; the minor side electrical connector submodule is disposed at the electrical connector minor side, and the minor side electrical connector submodule comprises a minor side non-grounded conductive terminal set, the minor side non-grounded conductive terminal set comprises a first minor side non-grounded conductive terminal and a second minor side non-grounded conductive terminal, wherein the minor side non-grounded conductive terminal separating space is disposed between the first minor side non-grounded conductive terminal and the second minor side non-grounded conductive terminal to separate the first minor side non-grounded conductive terminal from the second minor side non-grounded conductive terminal; and the first minor side non-grounded conductive terminal and the second minor side non-grounded conductive terminal extend into the coupling space to provide coupling; the coupling space shielding conductive member extends into the coupling space to provide electrical shielding between the major side non-grounded conductive terminal set and the minor side non-grounded conductive terminal set; the grounded conductive terminal extends into the major side non-grounded conductive terminal separating space at the electrical connector major side to provide electrical shielding between the first major side non-grounded conductive terminal and the second major side non-grounded conductive terminal, and the grounded conductive terminal further extends into the minor side non-grounded conductive terminal separating space at the electrical connector minor side to provide electrical shielding between the first minor side non-grounded conductive terminal and the second minor side non-grounded conductive terminal; the grounded conductive terminal further extends into the coupling space at the electrical connector major side and the electrical connector minor side to provide coupling; and the grounded conductive terminal comprises a coupling space shielding conductive member mating structure, the coupling space shielding conductive member mating structure is mated with the coupling space shielding conductive member to provide positioning for the coupling space shielding conductive member and electrically connect the grounded conductive terminal to the coupling space shielding conductive member.

In summary, the electrical connector of the present application can be disposed in an electronic device for signal transmission, and the electrical connector comprises a plurality of non-grounded conductive terminal sets, a shielding conductive member and a grounded conductive terminal. Wherein the shielding conductive member is disposed between the plurality of non-grounded conductive terminal sets, the grounded conductive terminal is capable of being electrically connected to the shielding conductive member to transmit a shielding signal such as a grounded signal to provide electrical shielding for signal transmission of the plurality of non-grounded conductive terminal sets. Thus, interference during high-speed signal transmission of the electrical connector can be effectively reduced, thereby optimizing the transmission quality of the electrical connector for high-speed signals to meet specific requirements and development of electronic devices.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. An electrical connector, two sides of the electrical connector being an electrical connector major side and an electrical connector minor side, the electrical connector comprising:
an electrical connector body comprising a coupling space, a major side non-grounded conductive terminal separating space, and a minor side non-grounded conductive terminal separating space;
a major side electrical connector submodule disposed at the electrical connector major side, the major side electrical connector submodule comprising a major side non-grounded conductive terminal set, the major side non-grounded conductive terminal set comprising a first major side non-grounded conductive terminal and a second major side non-grounded conductive terminal, wherein the major side non-grounded conductive terminal separating space is disposed between the first major side non-grounded conductive terminal and the second major side non-grounded conductive terminal to separate the first major side non-grounded conductive terminal from the second major side non-grounded conductive terminal, and the first major side non-grounded conductive terminal and the second major side non-grounded conductive terminal extend into the coupling space to provide coupling;
a minor side electrical connector submodule disposed at the electrical connector minor side, the minor side electrical connector submodule comprising a minor side non-grounded conductive terminal set, the minor side non-grounded conductive terminal set comprising a first minor side non-grounded conductive terminal and a second minor side non-grounded conductive terminal, wherein the minor side non-grounded conductive terminal separating space is disposed between the first minor side non-grounded conductive terminal and the second minor side non-grounded conductive terminal to separate the first minor side non-grounded conductive terminal from the second minor side non-grounded conductive terminal, and the first minor side non-grounded conductive terminal and the second minor side non-grounded conductive terminal extend into the coupling space to provide coupling;
a coupling space shielding conductive member extending into the coupling space to provide electrical shielding between the major side non-grounded conductive terminal set and the minor side non-grounded conductive terminal set; and
a grounded conductive terminal extending from the electrical connector major side into the major side non-grounded conductive terminal separating space to provide electrical shielding between the first major side non-grounded conductive terminal and the second major side non-grounded conductive terminal; the grounded conductive terminal further extending from the electrical connector minor side into the minor side non-grounded conductive terminal separating space to provide electrical shielding between the first minor side non-grounded conductive terminal and the second minor side non-grounded conductive terminal; the grounded conductive terminal further extending from the electrical connector major side and the electrical connector minor side into the coupling space to provide coupling; and the grounded conductive terminal comprising a coupling space shielding conductive member mating structure, wherein the coupling space shielding conductive member mating structure is mated with the coupling space shielding conductive member to position the coupling space shielding conductive member and to electrically connect the grounded conductive terminal to the coupling space shielding conductive member.

2. The electrical connector of claim 1, wherein the coupling space shielding conductive member is a conductive metal member.

3. The electrical connector of claim 1, wherein the coupling space shielding conductive member comprises a major side coupling space shielding conductive sub-member and a minor side coupling space shielding conductive sub-member; wherein the major side coupling space shielding conductive sub-member comprises a major side coupling space shielding conductive sub-member shielding wall extending from the electrical connector major side into the coupling space to provide electrical shielding between the major side non-grounded conductive terminal set and the minor side non-grounded conductive terminal set; and the minor side coupling space shielding conductive sub-member comprises a minor side coupling space shielding conductive sub-member shielding wall extending from the electrical connector minor side into the coupling space to provide electrical shielding between the major side non-grounded conductive terminal set and the minor side non-grounded conductive terminal set; and the coupling space shielding conductive member mating structure comprises a major side coupling space shielding conductive member mating substructure and a minor side coupling space shielding conductive member mating substructure, wherein the major side coupling space shielding conductive member mating substructure is mated with the major side coupling space shielding conductive sub-member to position the major side coupling space shielding conductive sub-member and to electrically connect the grounded conductive terminal to the major side coupling space shielding conductive sub-member, and the minor side coupling space shielding conductive member mating substructure is mated with the minor side coupling space shielding conductive sub-member to position the minor side coupling space shielding conductive sub-member and to electrically connect the grounded conductive terminal to the minor side coupling space shielding conductive sub-member.

4. The electrical connector of claim 3, wherein the major side coupling space shielding conductive sub-member further comprises a major side coupling space shielding conductive sub-member abutting wall, and the minor side coupling space shielding conductive sub-member further comprises a minor side coupling space shielding conductive sub-member abutting wall, wherein the major side coupling space shielding conductive sub-member abutting wall is configured to abut the minor side coupling space shielding conductive sub-member abutting wall to electrically connect the major side coupling space shielding conductive sub-member to the minor side coupling space shielding conductive sub-member.

5. The electrical connector of claim 4, wherein the major side coupling space shielding conductive sub-member further comprises a major side coupling space shielding conductive sub-member connecting wall, and the minor side coupling space shielding conductive sub-member further comprises a minor side coupling space shielding conductive sub-member connecting wall; wherein the major side coupling space shielding conductive sub-member connecting wall is configured to connect the major side coupling space shielding conductive sub-member shielding wall to the major side coupling space shielding conductive sub-member abutting wall; the minor side coupling space shielding conductive sub-member connecting wall is configured to connect the minor side coupling space shielding conductive sub-member shielding wall to the minor side coupling space shielding conductive sub-member abutting wall; the major side coupling space shielding conductive member mating substructure is mated with the major side coupling space shielding conductive sub-member connecting wall; and the minor side coupling space shielding conductive member mating substructure is mated with the minor side coupling space shielding conductive sub-member connecting wall.

6. The electrical connector of claim 5, wherein the major side coupling space shielding conductive sub-member connecting wall substantially perpendicularly intersects with the major side coupling space shielding conductive sub-member shielding wall and the major side coupling space shielding conductive sub-member abutting wall respectively; and the minor side coupling space shielding conductive sub-member connecting wall substantially perpendicularly intersects with the minor side coupling space shielding conductive sub-member shielding wall and the minor side coupling space shielding conductive sub-member abutting wall respectively.

7. The electrical connector of claim 1, wherein the major side electrical connector submodule further comprises a major side terminal insulation core mated with the major side non-grounded conductive terminal set to position the first major side non-grounded conductive terminal and the second major side non-grounded conductive terminal; the minor side electrical connector submodule further comprises a minor side terminal insulation core mated with the minor side non-grounded conductive terminal set to position the first minor side non-grounded conductive terminal and the second minor side non-grounded conductive terminal; and the grounded conductive terminal further comprises a major side terminal insulation core mating structure and a minor side terminal insulation core mating structure, wherein the major side terminal insulation core mating structure is mated with the major side terminal insulation core to position the major side terminal insulation core, and the minor side terminal insulation core mating structure is mated with the minor side terminal insulation core to position the minor side terminal insulation core.

8. The electrical connector of claim 7, further comprising: an insulation housing mated with the major side terminal insulation core and the minor side terminal insulation core to position the major side terminal insulation core and the minor side terminal insulation core.

9. The electrical connector of claim 1, wherein the electrical connector body further comprises a engaging space; the first major side non-grounded conductive terminal and the second major side non-grounded conductive terminal further extend into the engaging space to provide engaging; the first minor side non-grounded conductive terminal and the second minor side non-grounded conductive terminal further extend into the engaging space to provide engaging; the grounded conductive terminal further extends from the electrical connector major side and the electrical connector minor side into the engaging space to provide engaging; the electrical connector further comprises a engaging space shielding conductive member extending into the engaging space to provide electrical shielding between the major side non-grounded conductive terminal set and the minor side non-grounded conductive terminal set; and the grounded conductive terminal further comprises a engaging space shielding conductive member mating structure mated with the engaging space shielding conductive member to position the engaging space shielding conductive member and to electrically connect the grounded conductive terminal to the engaging space shielding conductive member.

10. The electrical connector of claim 9, wherein the engaging space shielding conductive member is a conductive plastic member.
